(19) United States
(12) Patent Application Publication
(10) Pub. No.: US 2003/0026869 A1
(43) Pub. Date: Feb. 6, 2003

(54) Direct transfer conveying mechanism

(76) Inventors: Charles Weber, Onalaska, WI (US); Scott Ledebuhr, St. Charles, MN (US)

Correspondence Address: MOORE & HANSEN, 2900 WELLS FARGO CENTER, 90 SOUTH SEVENTH STREET, MINNEAPOLIS, MN, 55402, US

(21) Appl. No.: 09/922,971

(22) Filed: Aug. 6, 2001

(51) Int. Cl. B29C 45/54

(52) U.S. Cl. 425/557; 264/328.1; 425/559

(57) ABSTRACT

A conveying device that permits the continuous accumulation and intermittent injection a molding material is herein disclosed. The conveying device comprises a housing having a bore with an inlet and an outlet and a shaft reciprocable disposed within the bore. The shaft and bore are constructed and arranged to form an annular space therebetween. A slip ring is slidably captured on the reciprocable shaft and may travel longitudinally on the shaft between a forward position and a rearward position. When the shaft is retracted from the bore, the slip ring moves to its forward position on the shaft and the molding material may flow between an inner surface of the slip ring and the shaft. When the shaft is inserted into the bore, the slip ring moves to its rearward position and the slip ring acts as a piston head and forces the molding material from the bore and into a downstream molding or handling mechanism.

### CROSS REFERENCE TO RELATED APPLICATIONS

None.

### FIELD OF THE INVENTION

The present invention relates generally to the extrusion of thermoplastic resins with reinforcing fibers. More particularly, the present invention relates to a direct transfer conveying mechanism that permits the direct transfer of thermoplastic resins containing reinforcing fibers and the like from an extruder used to combine the thermoplastic resins with the reinforcing fibers to a molding mechanism.

### BACKGROUND OF THE INVENTION

Injection molding using fiber reinforced thermoplastic resins has heretofore been a two-part process. In the first part of this process, thermoplastic resins are combined in an extruder with reinforcing fibers at a predetermined ratio. The molten thermoplastic resins containing the reinforcing fibers are then extruded into pellets that are used in the second part of this procedure. The thermoplastic resin pellets containing the reinforcing fibers are then used in a molding process wherein the preformed thermoplastic resin pellets containing the reinforcing fibers are placed in a second extruder that melts and mixes pellets into a molten mass that is transferred into a standard injection press for subsequent injection into a mold.

The main disadvantage with the two-part process set forth above is the relative high cost of this process. Injection molding manufacturers must purchase the fiber filled thermoplastic resin pellets from a previous compounder, thereby adding to the cost of the fiber filled thermoplastic resin pellets the overhead expenses of the previous compounder. In addition, problems may arise with the pellets themselves. Loose fibers from the pellets have a tendency to plug the feed throat of injection machines and auxiliary equipment and the additional extrusion processing tends to cut or break the reinforcing fibers in the thermoplastic resin, thereby negatively affecting the mechanical strength of the finished products.

Another method for producing articles from fiber reinforced thermoplastic resin is compression molding. There are two types of compression molding that utilize fiber reinforced thermoplastic resins. The first involves the use of fiber reinforced thermoplastic sheets that are produced by injecting a fiber mat with molten thermoplastic resin. These sheets are then cut into predetermined shapes, usually square or rectangular, to prepare them for the compression molding. The prepared fiber reinforced thermoplastic sheets are placed in an oven to soften the thermoplastic resin before being transferred to the compression molding press. The press is then closed to apply pressure to the heated fiber reinforced thermoplastic sheet for a predetermined amount of time until the composite sheet is cooled and hardened into the desired molded shape.

Unfortunately, the costs of using of fiber reinforced thermoplastic sheets in compression molding are inherently high. This stems in part from the increased material handling requirements of this process and in the high number of rejected parts that may result where the fiber reinforced thermoplastic sheets fail to fill cavities in the compression press molds. In addition, compression molding using fiber reinforced thermoplastic sheets has a tendency to unevenly distribute the reinforcing fibers in the finished molded products. This can adversely affect the mechanical characteristics of the finished products themselves.

The second method of compression molding utilizes a fiber reinforced thermoplastic resin bulk-molding compound that is provided by an extruder that mixes thermoplastic resin pellets with a suitable reinforcing fiber. A method and apparatus for preparing fiber reinforced thermoplastic resin molding compound is disclosed in U.S. Pat. No. 5,185,117, herein incorporated by reference. The bulk-molding compound produced by the mixing extruder is fed into an accumulator device that typically incorporates a reciprocable auger and a chamber. As the bulk-molding compound fills the accumulator chamber, the auger backs up to a predetermined set point. When the set point has been reached, a gate opens and the auger pushes the predetermined quantity of bulk molding compound out of the gate. This predetermined quantity of bulk molding compound is referred to as a preform. The preform is then transferred to a mold in a compression molding press. The molding press closes the mold and holds the mold under a certain pressure for a predetermined amount of time to allow the molding compound to cool into the form of the finished product. While relatively simple, the use of bulk molding compound in compression molding incurs high material handling costs. Typically, the preforms produced by the mixing extruders must be transferred to a press, either manually or using robotics. Either method adds significantly to the cost of this process.

### SUMMARY OF THE INVENTION

Consequently, it is an object of the present invention to provide a structure and method for directly transferring fiber reinforced thermoplastic resins from a compounding extruder directly to an injection or compression molding device.

These objects are realized in a conveying device for continuously accumulating and intermittently conveying a molding material that comprises a housing having a bore and an inlet and an outlet formed therein for passing molding material through the bore. While the outlet may be arranged in many ways, it is preferred that the outlet of the housing be substantially longitudinally aligned with the bore formed through the housing.

A shaft is reciprocally received within the bore in the housing and has a rear portion that forms a tight, sliding fit with the bore of the housing and a forward portion having a dimension smaller than that of the bore. A tapered portion of the shaft forms a transition between the forward and rear portions of thereof.

A slip ring that acts as a valve element is disposed within the bore of the housing and is slidably captured over the forward portion of the shaft between the tapered portion of the shaft and a retaining structure affixed to a distal end of the forward portion of the shaft. In a preferred embodiment, the retaining structure of the shaft comprises a plurality of vanes that are spaced equidistantly around the distal end of the forward portion of the shaft. The slip ring has an outer surface that forms a tight sliding fit with the bore of the housing and an inner surface that is constructed and arranged so as to form an annular passage between the slip ring and shaft when the slip ring is positioned away from the tapered portion of the shaft. The inner surface of the slip ring is also complementary with the tapered portion of the shaft so that when the slip ring abuts the tapered portion of the shaft the bore will be substantially sealed by the slip ring.

The shaft is reciprocable within the bore of the housing between a rearmost position and a forward-most position. The slip ring is also reciprocable between a forward-most position in which the slip ring bears against the retaining structure and a rearmost position in which the inner surface of the slip ring bears against the tapered portion of the shaft so as to seal the bore. The slip ring is moved toward its forward-most position by the travel of the shaft from its forward-most position to its rearmost position. Conversely, the slip ring is moved towards its rearmost position by the travel of the shaft from its rearmost position to its forward-most position.

The conveying device of the present invention may also be described as comprising a housing having a bore with a rear portion and a forward portion. The housing further has an inlet formed therethrough that is in fluidic communication with the forward portion of the bore and an outlet that also is in fluidic communication with the forward portion of the bore in a position that is spaced apart from that of the inlet. A shaft constructed and arranged for reciprocal movement is disposed within the bore of the housing. The shaft has a rear portion that is sized so as to form a tight, sliding fit with the rear portion of the bore and a forward portion that has a diameter that is at least marginally smaller than that of the forward portion of the bore. The forward and rear portions of the shaft are joined by a transition surface that may have one of many suitable shapes, including frustoconical and radiused. A slip ring is slidably disposed within the bore of the housing and slidably captured over the forward portion of the shaft between the transition surface and a retaining structure that is affixed to a distal end of the forward portion of the shaft. The slip ring has an outer surface that forms a tight sliding fit with the forward portion of the bore and an inner surface that is spaced away from the exterior of the forward portion of the shaft so as to form an annular space therebetween. The inner surface of the slip ring also has a shape that is complementary to the shape of the transition surface of the shaft such that when the inner surface of the slip ring is abutted against the transition surface of the shaft, viscous materials may not flow past the slip ring. When the slip ring abuts the transition surface, the shaft and slip ring effectively become a piston for forcing viscous materials from the bore of the housing through the outlet. The slip ring is moved into its position abutting the transition surface of the shaft by the forward movement of the shaft from a first, retracted position, to a second, extended position. Movement of the shaft from its second, extended position towards its first, retracted position causes the slip ring to be moved away from the transition surface of the shaft, thereby creating an annular flow channel between the inner surface of the slip ring and the exterior surface of the forward portion of the shaft. In this position, viscous materials may flow between the slip ring and the shaft into the forward portion of the housing bore.

One benefit of the present invention is that it allows a compounding device such as an extruder to operate continuously; viscous molding materials are continuously pumped into the forward portion of the bore of the housing through the inlet formed through the housing. The viscous molding materials are then intermittently ejected from the forward portion of the bore through the outlet and into a downstream device that is typically some sort of molding, accumulating, or forming device.

An alternate embodiment of the present invention further comprises a housing having a bore formed therein. The bore has an inlet and an outlet formed through the housing. A reciprocable collar is slidably received within an open end of the bore formed in the housing. The collar has an exterior surface that forms a tight sliding fit with the interior of an open end of the bore. The shaft of the conveying device is reciprocally received within the collar received in the open end of the bore, with the exterior of the shaft forming a tight sliding fit with the interior surface of the collar. The shaft is sized such that an annular space exists between the shaft and the bore of the housing between the inlet and outlet of the bore; the inlet and outlet of the bore being in fluidic communication with this annular space. The shaft may also have a forward portion with a smaller diameter than the rear portion of the shaft. Where this is the case, the forward and rear position of the shaft are joined together a transition surface.

A slip ring is slidably received within the bore and captured over the forward portion of the shaft. The slip ring may slide longitudinally within the bore and has an outer surface that forms a tight sliding fit with the bore of the housing. The slip ring may be moved longitudinally with respect to the shaft between the transition surface of the shaft between the forward and rear portions of the shaft and a retaining structure coupled to a distal end of the forward portion of the shaft. The inner surface of the slip ring is sized so as to create an annular space or other flow channel or opening between the slip ring and the forward portion of the shaft. In addition, the inner surface of the slip ring is constructed and arranged to be complementary with the transition surface of the shaft.

The forward movement of the shaft from a first, retracted position, to a second, extended position, causes the inner surface of the slip ring to abut the transition surface of the shaft. The tight sliding fit between the exterior surface of the slip ring and the bore and the close, complementary fit between the transition surface of the shaft and the inner surface of the slip ring effectively forming a piston head that pushes viscous material ahead of it as the shaft moves between its first and second positions. In this manner, viscous materials such as resinous molding materials may be intermittently conveyed from the conveying device. The travel of the shaft from its second, extended position towards its first, retracted position, causes the slip ring to be moved away from the transition surface of the shaft, thereby opening a flow channel between the inner surface of the slip ring and the exterior surface of the forward portion of the shaft. This permits the flow of viscous materials into the forward portion of the housing bore and facilitates the continuous accumulation of the viscous materials within the annular space between the shaft and bore.

The position of the collar within the bore is can be used to control the volume of the annular space formed between the shaft and the bore of the housing as the collar regulates the length of that annular space. This is an important feature in that the pressure of the viscous materials within the annular space may itself be controlled by increasing or decreasing the volume of the annular space.

Another embodiment of the present invention comprises a housing having a bore formed entirely therethrough. The bore has a rear portion and a forward portion and an inlet formed therethrough that is in fluidic communication with the forward portion of the bore. A reciprocable shaft having a rear portion and a forward portion is disposed within the housing. The shaft preferably has a substantially uniform diameter. The rear portion of the shaft forms a tight sliding fit with the rear portion of the bore of the housing. The respective forward portions of the bore and shaft are constructed and arranged to form an annular space of predetermined volume therebetween.

An annular slip ring is slidably captured over the forward portion of the shaft. The outer surface of the slip ring forms a tight sliding fit with the forward portion of the bore and the inner surface of the slip ring forms a tight, sliding fit with the forward potion of the shaft. The slip ring is free to travel longitudinally with respect to the shaft between a first, rearward position defined by a first retaining structure coupled to the shaft, and a second, forward position defined by a second retaining structure of the shaft. The forward portion of the shaft has one or more longitudinal grooves formed therein that extend from forward of the second retaining structure rearward along the shaft, stopping short of the first retaining structure. The longitudinal grooves are formed such that when the slip ring is in its first, rearward position, the inner surface of the slip ring forms a seal between the respective forward sections of the bore and the shaft. When the slip ring is in its forward position, viscous materials are able to flow between the slip ring and the forward portion of the shaft through the longitudinal groove or grooves. Movement of the slip ring between its first and second positions imposed by the movement of the shaft between its own rearward and forward positions. The slip ring is moved from its first, rearward position to its second, forward position as the shaft moves rearward and to its rearward position from its forward position as the shaft moves forward.

Many different structures may function as a retaining device. Examples include a stud coupled to the shaft, a transition surface machined into the shaft between the rear portion of the shaft and the forward portion of the shaft, a collar affixed to the shaft and one or more vanes extending radially from the shaft. The transition surface machined into the shaft may be a frustoconical surface, a radiused surface (simple or complex radii), or a flat shoulder that is 90° to the axis of the shaft.

The present invention may also be expressed as a method for continuously accumulating and intermittently conveying a molding material from a conveying device. As described above, such a conveying device comprises a housing having a bore with a rear portion and a forward portion, an inlet formed through the housing so as to be in fluidic communication with the forward portion of the bore, and an outlet that is in fluidic communication with the forward portion of the bore in a position that is spaced apart from that of the inlet. A shaft constructed and arranged for reciprocal movement is disposed within the bore of the housing. The shaft has a rear portion sized so as to form a tight, sliding fit with the rear portion of the bore and a forward portion that has a diameter that is at least marginally smaller than that of the rear portion of the bore. The forward and rear portions of the shaft are joined by a transition surface and a slip ring that is slidably disposed within the bore of the housing and captured over the forward portion of the shaft between the transition surface and a retaining structure affixed to a distal end of the forward portion of the shaft. The slip ring has an outer surface that forms a tight sliding fit with the forward portion of the bore and an inner surface that has a shape that is complementary to the shape of the transition surface of the shaft such that when the inner surface of the slip ring is abutted or otherwise positioned adjacent or against the transition surface of the shaft, viscous material may not flow past the slip ring. The inner surface of the slip ring and the shaft are formed such that there exists a flow channel therebetween when the slip ring is positioned away from the transition surface of the shaft. The method steps include continuously injecting a molding material into the annular passage formed between the forward portion of the interior of the bore formed through the housing and the forward portion of the shaft so that the molding material will continuously be accumulated in the annular passage. Retracting the shaft to a first, retracted position wherein the slip ring slidably captured on the forward portion of the shaft abuts the retaining structure affixed to the distal end of the shaft so that the molding material may flow between the inner surface of the slip ring and the forward portion of the shaft. When desired, the shaft is extended to a second, extended position wherein the slip ring slidably captured on the forward portion of the shaft is positioned against the retaining structure immediately adjacent the transition surface. The slip ring acts to push the molding material accumulated forward of the slip ring from the housing of the conveying device through the outlet of the bore.

These and other objectives and advantages of the invention will appear more fully from the following description, made in conjunction with the accompanying drawings wherein like reference characters refer to the same or similar parts throughout the several views.

### DESCRIPTION OF THE DRAWINGS

FIG. 1 is a schematic cross-section view of a direct transfer mechanism of the present invention comprising a pressure relief sleeve.

FIG. 2 is a schematic cross-section of a direct transfer device according to the present invention.

FIG. 3 is a cross-sectional view taken along cutting lines 3-3 in FIG. 1.

FIG. 4 is a schematic cross-section of an alternate embodiment of a direct transfer device according to the present invention.

### DETAILED DESCRIPTION

Although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention, which is defined by the claims.

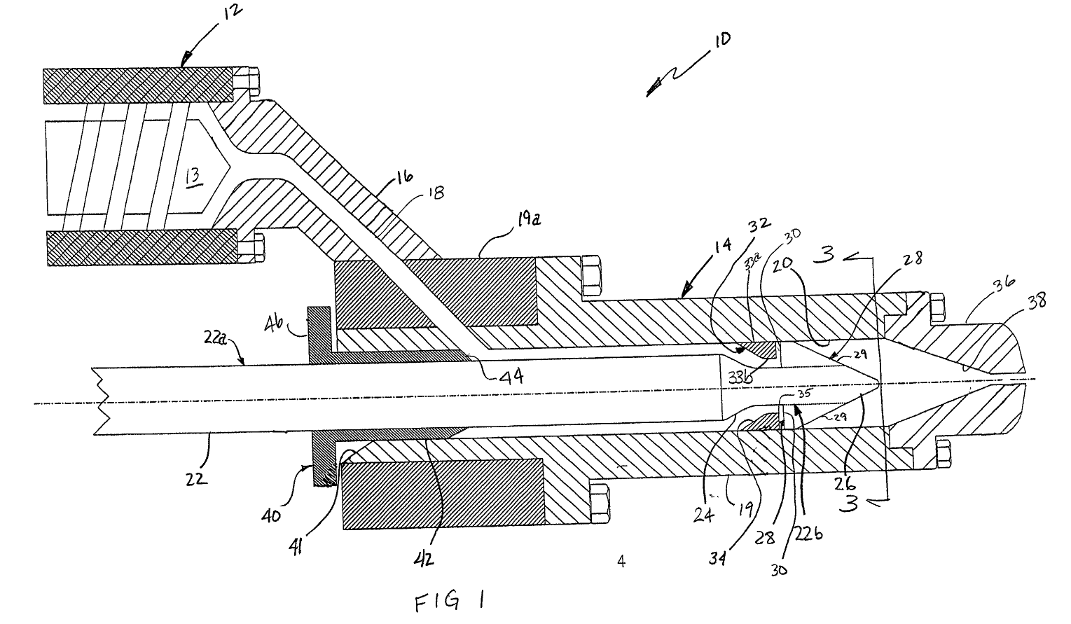

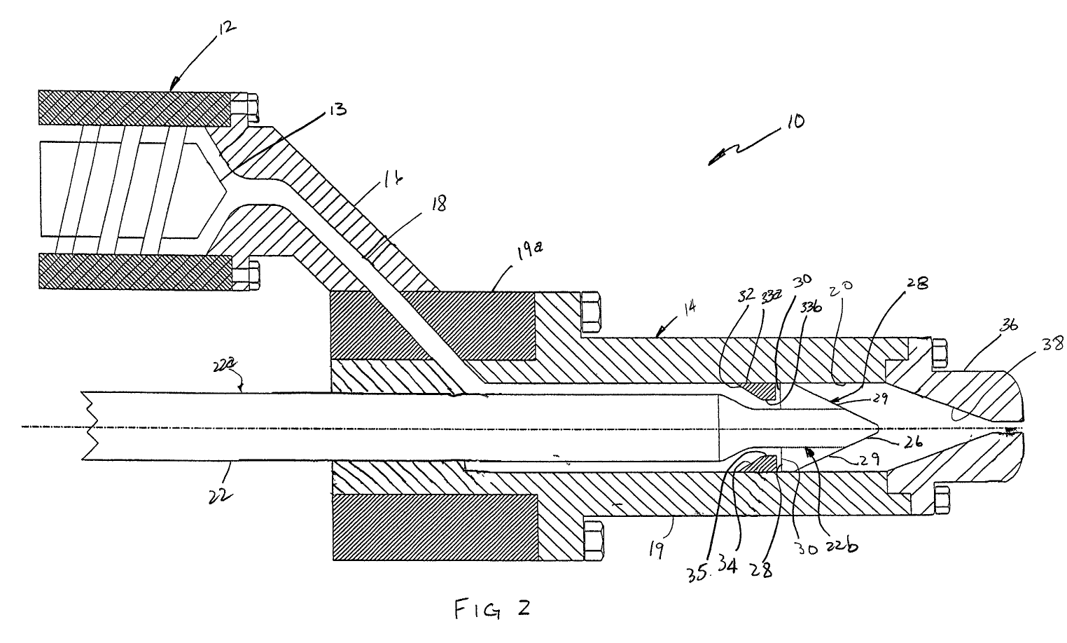

A direct transfer conveying mechanism 10 constructed according the present invention comprises a compounding extruder 12 and an injection press 14. As can be seen in FIGS. 1 and 2, the conveying mechanism 14 is coupled to the extruder 12 so as to receive directly therefrom molding material comprising a mixture of resin and reinforcing fibers. An example of a suitable compounding extruder is disclosed in U.S. Pat. No. 5,185,117 to Ronald C. Hawley, hereby incorporated by reference.

Extruder 12 is coupled to the conveying mechanism 14 by an adaptor fitting 16. Adaptor fitting 16 has an interior passage 18 through which molding material prepared by the extruder 10 is transmitted into the inner bore 20 of the injector 14. Molding material is pushed by feed screw 13 of extruder 12 through passage 18 into the bore 20 of the injector 14.

The injector housing 19 may be a solid construction or may comprise numerous parts connected as by bolting or the like to form a unitary whole. For example, collar portion 19a may be constructed and arranged to fit over the housing 19 for the purpose of providing a point of connection whereby the conveying mechanism 14 may be secured to a stand or support (not shown).

Conveying mechanism or injector 14 essentially comprises a housing 19 having a bore 20 formed therethrough. Preferably, the bore 20 will be uniform throughout its length, however it is envisioned that the bore 20 may be broken up into portions having varying radii. Injector shaft 22 is disposed within the bore 20 of the injector 14. The shaft 22 is longitudinally reciprocal within bore 20 of injector 14. The shaft 22 has a base portion 22a having a substantially cylindrical cross-section and a forward portion 22b having a somewhat smaller cylindrical cross-section. A tapered portion 24 of the shaft 22 marks the boundary between the base portion 22a and the forward portion 22b of the shaft 22. The tapered portion 24 of the shaft 22 is generally frustoconical in shape with the transition point between the tapered portion and the respective base and forward portions 22a, 22b being gently radiused. In a preferred embodiment of the present invention, the forward portion 22b has a tip 26 that gradually tapers to a point. Vanes 28 extend from the forward portion of the shaft 22b and contact the sides of the bore 20 of the conveying mechanism 14 so as to center the shaft 22 within the bore 20. While any number of vanes 28 may be disposed around the forward portion 28b of the shaft 22, it is preferred to utilize two vanes 28 spaced 180 degrees from one another around the forward portion 22b of the shaft. Note that a leading edge 29 of the vanes continues the taper of the tip 26 of the shaft 22, lending the front portion 22b of the shaft 22 the look of an arrowhead. Preferably, the leading edge 29 and trailing edge 30 of each of the vanes 28 will be given an aerodynamic shape to ease the flow of molding material therepast. Note that while the arrowhead configuration of the forward portion of the shaft 22b and the vanes 28 is a preferred embodiment of the present invention, many equivalent structures capable of centering the shaft 22 in the bore 20 and retaining a slip ring 32 on the shaft 22 are also contemplated. Alternatively, because the shaft 22 is substantially rigid, it may be possible and desirable to utilize a retaining structure that extends radially only so far as is needed retain the slip ring 32 on the shaft 22.

The aforementioned slip ring 32 is slidably disposed within the bore 20 of the conveying mechanism 14 and captured between the vanes 28 and the tapered section 24 of the shaft 22. An exterior surface 33a of the slip ring forms a tight fitting sliding seal between the slip ring 32 and the surface of the bore 20. An inner diameter 33b of the slip ring 32 is larger than the outer diameter of the forward portion of the shaft 22b and when the slip ring 32 abuts vanes 28, molding material may flow between the shaft 22 and the slip ring 32. Because the slip ring 32 is captured between the tapered portion 24 of the shaft 22 and the vanes 28, the slip ring 32 is constrained to slide longitudinally with the shaft 22. As the shaft moves rearwardly, towards the left in FIGS. 1 and 2, the vanes 28 will abut the flat portion 35 of the slip ring 32, thereby forcing the slip ring to move rearwardly with the shaft 22. As the shaft 22 and slip ring 32 move rearwardly, molding material flows between the inner diameter 33b of slip ring 32 and the forward portion 22b of the shaft and is accumulated within the forward portion of the bore 20 of the conveying mechanism 14 between the tip 26 of the shaft 22 and the coupling 36. As the shaft 22 moves forward, toward the right in FIGS. 1 and 2, the tapered portion 24 of the shaft 22 will abut against the complementary frustoconical surface 34 of the slip ring, thereby causing the slip ring 32 to move forward with the shaft 22. As the shaft 22 moves forward, the tight fit between the slip ring 32 and the shaft 22 and bore 20 effectively transforms the shaft 22 and slip ring 32 into a piston that forces the accumulated molding material from the conveying mechanism 14 through coupling 36.

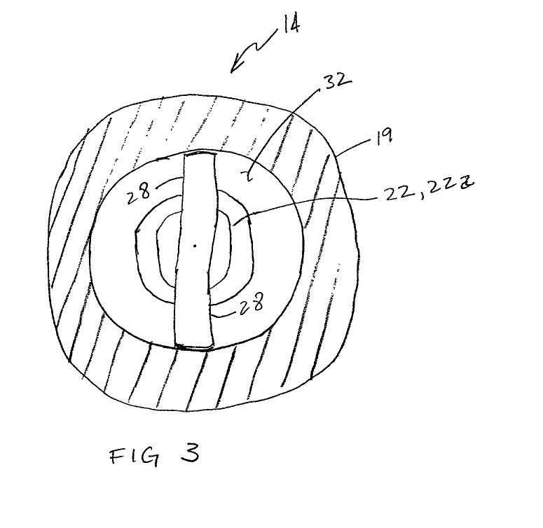

FIG. 3 illustrates a cross-section of the conveying device 14 of the present invention and specifically shows the vanes 28 and slip ring 32. Vanes 28 are preferably disposed equilaterally about the shaft 22 and act to support the forward end 22b of the shaft 22. In addition, the spaces between the vanes 28 provide a flow path for molding materials that are being accumulated within the conveying device 14.

Adaptor coupling 36 is coupled to the forward end of the housing of the injector 14. Adaptor 36 has an inner passage 38 having a portion that is complementary to the shape of the tip 26 and vanes 28 of the shaft 22. Coupling 36 may be adapted to connect the conveying mechanism 14 to any desirable output device. Suitable output devices include injection molding machines and compression molding devices. It is envisioned that other applications for the present invention may also be adapted for use therewith.

The base portion 22a of the shaft 22 may be supported as illustrated in FIG. 2 by a rear portion of the bore 20 having a smaller diameter than the forward portion of the bore 20. The base portion 22a of the shaft 22 illustrated in FIG. 2 forms a close sliding fit within the reduced diameter portion of the bore 20. Preferably, the base portion of the shaft 22b and the bore 20 are sufficiently close fitting to prevent molding material from entering therebetween. Alternatively and preferably, a base portion 22a of the shaft 22 is slidably supported within a longitudinally slidable sleeve 40. Sleeve 40 comprises a forward hollow cylindrical portion 42 that has an inner diameter sized to receive therein the base portion 22a of shaft 22 in a close sliding fit. The forward cylindrical portion 42 of the sleeve 40 has an exterior diameter sized to be slidably received within the bore 20 in a close sliding fit. The fits between the bore 20, cylindrical portion 42 of sleeve 40, and the base portion 22a of shaft 22, are sufficiently close fitting so as to prevent the ingress of molding material therebetween. Preferably, a leading edge 44 of the sleeve 40 is tapered as illustrated in FIG. 1, though this leading edge 44 may be blunt or of any desirable shape. Collar 46 is secured to the cylindrical portion 42 of the sleeve 40 so as to prevent the cylindrical portion 42 from entering into the bore 20. Preferably, sleeve 40 will be biased into bore 20 by any suitable mechanical or hydraulic means. Where molding material present within the bore 20 exerts a pressure force against the leading edge 44 of the sleeve 40 that exceeds a predetermined safe limit, the sleeve 40 will slowly back out of bore 20, thereby increasing the volume of bore 20 and reducing the pressure of the molding material therein. Preferably bore 20 will be provided with a pressure sensing device (not shown) such as a pressure transducer disposed within the wall of the housing of the conveying mechanism 14 so as to provide pressure data useful in the control of the longitudinal position of the sleeve 40 within bore 20. Preferably the position of the sleeve 40 will be controlled by a hydraulic cylinder, not shown, though position of the sleeve 40 may ultimately be controlled by any means or structure that is suited to that use. Note that a pressure sensing device such as a pressure transducer will not be necessary where the longitudinal position of the sleeve 40 within the bore 20 is controlled by mechanical means such as a spring.

A small chamfer or channel 41 may be formed into the injector housing 19 to provide a flow channel for resins. The flow channel 41 will be in fluidic communication with the bore 20 for the injector housing 19 when sleeve 40 has been sufficiently withdrawn from the bore 20. In this manner, resinous molding materials within the bore 20 may be evacuated from the bore 20 before the sleeve 40 is completely withdrawn from the bore 20. Note that this chamfer or channel 41 is optional and may be omitted from the present invention where so desired.

Tolerances between the bore 20, shaft 22, and slip ring 32 are fairly critical. Where a near perfect fit is formed between the bore 20, shaft 22, and slip ring 32, as the shaft 22 moves forward within the bore 20 in pushing the molding material from the bore 20, a vacuum may be created behind the slip ring 32 within bore 20. Similarly, a vacuum may be created within the bore 20 in front of the slip ring 32 as the shaft 22 travels back to its starting position. Therefore, it is necessary to maintain tolerances between the bore 20, shaft 22, and slip ring 32 that permit air, but not the molding materials to pass between the slip ring 32 and the bore 20. A preferred embodiment of the present invention successfully utilizes a tolerance between the slip ring 32 and bore 20 of under four thousandths of an inch. This tolerance permits air to pass between the slip ring 32 and the bore 20 and thereby prevents the formation of a vacuum. In addition, due to the relatively high viscosity of most molding materials, the four thousandths or less tolerance between the slip ring 32 and the bore 20 prevents the molding materials from passing between the slip ring 32 and the bore 20. It is to be noted that the specific tolerances recited here may be varied depending upon the application of the present invention. Generally speaking, the higher the viscosity of the molding materials, the larger the tolerances may be and vice versa. Where a specific tolerance is to be maintained throughout the conveying mechanism 14, smaller tolerances between the slip ring 32 and the bore 20 may be accounted for by providing suitably sized clearance holes through the slip ring 32 or by forming small grooves in the surface of the bore 20, as the case may be.

In operation, molding material that has been compounded by extruder 12 is forced from extruder 12, through passage 18 and into the conveying mechanism 14. As indicated above, shaft 22 is longitudinally reciprocal within the bore 20. The arrangement of the shaft 22 and slip ring 32 are such that composite material produced by extruder 12 may be continuously pumped into the conveying mechanism 14 regardless of the longitudinal position of the shaft 22. The shaft 22 moves between a first, extended position in which the tip 26 of the shaft 22 is located within the passage 38 of the fitting 36 and a second, retracted position in which the tip 26 of the shaft 22 is located adjacent the junction of passage 18 and bore 20. Note that the shaft 22 may not be retracted so far as to allow the slip ring 32 to occlude passage 18.

As indicated above, as the shaft 22 moves rearwardly from its first position to its second position, vanes 28 abut against surface 35 of slip ring 32, thereby causing the slip ring 32 to slide with the shaft 22 towards the rear of the injector 14. Note that in this position, there exists a passage between the exterior surface of the forward portion 22b of the shaft 22 and the inner diameter 33b of the slip ring 32. In this manner, molding material flowing from the extruder 12 and into the conveying mechanism 14 may pass between the shaft 22 and the slip ring 32 to be accumulated within the bore 20 between the tip 26 of the shaft and the fitting 36. The exact longitudinal position of the shaft 22 within the bore 20 when the shaft 22 is in its second, retracted position is related directly to the quantity of composite material necessary to supply a chosen output device. Therefore, where larger devices are being molded, and thereby requiring a larger quantity of molding material, the shaft 22 will retract farther to the left as illustrated in FIGS. 1 and 2. Conversely, where smaller items are being molded, thereby requiring smaller quantities, the second, retracted position of the shaft 22 will be located nearer to the right of the injector 14. The longitudinal position of the shaft 22 may be controlled by any suitable mechanical or hydraulic means. Preferably, the distal end of the base portion 22a of the shaft 22 will be connected to the piston of a hydraulic cylinder that will control the longitudinal position of the shaft.

As the shaft 22 is moved from its second, retracted position to its first, extended position, the shaft 22 will at least at first move independent of the slip ring 32 as the shaft 22 moves forward. As the shaft 22 moves to its first, extended position, the tapered portion 24 of shaft 22 will contact the complementary tapered portion 34 of the slip ring 33, thereby forcing the slip ring forward with the shaft 22. When the tapered portion 24 of shaft 22 is in contact with the complementary tapered portion 34 of the slip ring 32, the close fitting abutment of the slip ring with the shaft 22 prevents the flow of molding material therebetween, effectively forming a piston head that pushes any molding material accumulated within the bore 20 ahead of the slip ring 32 into passage 38 of fitting 36 and subsequently into a chosen output device. As the shaft 22 moves toward its first, extended position, extruder 12 fills the space between bore 20 and the base portion 22a of shaft 22 with molding material. After reaching its first, extended position, shaft 22 begins to move rearward towards its second, retracted position, thereby causing the slip ring 32 to lose contact with the tapered surface 24 of the shaft. Subsequently, the vanes 28 will again bear against the base 35 of the slip ring 32 and cause it to move rearwardly. In this position, composite material accumulated within the bore 20 behind the slip ring 32 may pass between the slip ring 32 and the forward portion 22b of shaft 22 and into the forward portion of the bore 20 adjacent the fitting 36.

Outflow of the molding material from the conveying mechanism 14 through passage 38 is typically controlled with a valve (not shown). The opening and closing of this valve will typically coincide with the stroke of the shaft 22 such that the valve will be open as the shaft 22 moves towards its first, extended position. However, it sometimes happens that an output device such as an injection molding machine is not available to receive a quantity or shot of molding material at a given time. This may be caused by a failure of the mold to timely eject a previously molded piece or some similar error. When this occurs, it is necessary for the shaft 22 to be halted to avoid exceeding a predetermined safety pressure within the injector 14, but because extruder 12 operates in a continuous manner, molding material will be continuing to be fed through passage 18 into the conveying mechanism 14 even while shaft 22 is halted. It is at this point that sleeve 40 is brought into play. Where the shaft 22 has been halted due to an increase in pressure or where the molding process has been temporarily halted or delayed, sleeve 40 may be gradually backed out of bore 20 to maintain the pressure of the molding material within the conveying mechanism 14 below a predetermined upper limit. When the valve (not shown) controlling flow of the molding material through passage 38 is subsequently opened, shaft 22 will again begin to move towards its first, extended position and sleeve 40 will gradually be reinserted into bore 40 to its beginning position. Note that because of the extra volume contained within the extruder 14, the sleeve 40 may not return to its initial position immediately. Instead, the extra molding material accumulated within the bore 20 will be removed therefrom over the course of a relatively few injection cycles.

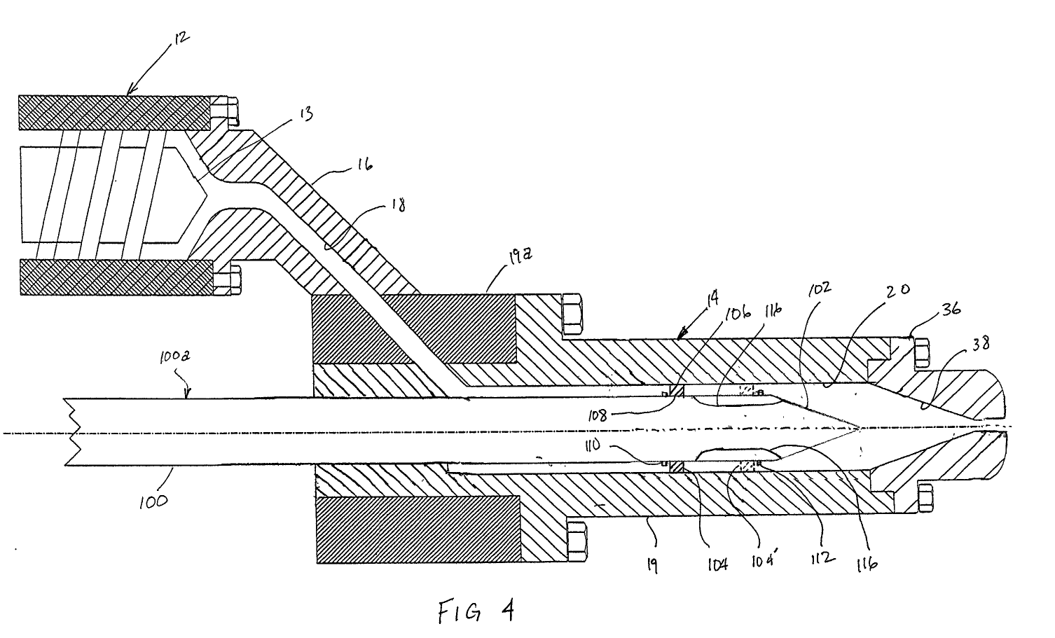

An alternate embodiment of the present invention is illustrated in FIG. 4. In FIG. 4 is illustrated a housing 19 having a bore 20 formed therethrough. The shaft 100 has a preferably uniform diameter that forms a tight sliding fit with the rear portion 100a of the bore 20. The forward end 102 of the shaft 100 is illustrated as being pointed in a manner that is complementary to the passage 38 of fitting 36. The slip ring 104 captured over the forward end 102 of the shaft 100 is annular in shape, having an exterior surface 106 that forms a tight sliding fit with the bore 20. The inner surface 108 of the slip ring 104 forms a tight sliding fit with the shaft 100, regardless of its position thereon. The slip ring 104 is illustrated in FIG. 4 in solid lines in its rearward position abutting a first retaining structure 110. The slip ring is illustrated in phantom in its forward position abutting a second retaining structure 112 as indicated by reference numeral 104¹. The first and section retaining structures 110, 112 may be any suitable structure for limiting the travel of the slip ring 104 upon the shaft 100, including a transition surface or vanes as described above. However, a preferred structure for the first and second retaining structure comprises a ring or collar affixed to the shaft 100 as by bolting. In order to allow molding materials to flow past the slip ring 104, one or more longitudinal grooves 116 are formed in the shaft 100. The longitudinal grooves 116 start forward of the second retaining structure 112 and continue rearward along the shaft 100 to a position short of the first retaining structure 110. Position, length, and area of the longitudinal grooves 116 may be varied to suit a given application of the present invention. However, the longitudinal grooves 116 must be spaced away from the first retaining structure 110 a sufficient distance to permit the inner surface 108 of the slip ring 104 to have sufficient contact with the shaft 100 to effectively seal the bore 20 of the housing 19. The embodiment illustrated in FIG. 4 operates in substantially the same manner as do the embodiments illustrated in FIGS. 1-3.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A conveying device for continuously accumulating and intermittently conveying a molding material, the device comprising:
a housing having a bore formed therethrough, the bore having an inlet and an outlet formed therein for passing molding material through the bore;
a shaft reciprocably received within the bore in the housing, the shaft having a rear portion forming a tight, sliding fit with the bore of the housing and a forward portion having a dimension smaller than that of the bore, the rear and forward portions of the shaft being joined by a transition portion;
a slip ring disposed within the bore of the housing and slidably captured over the forward portion of the shaft between the transition portion of the shaft and a retaining structure affixed to a distal end of the forward portion of the shaft, the slip ring having an outer surface that forms a tight sliding fit with the bore of the housing and an inner surface spaced away from the forward portion of the shaft so as to form a flow passage between the inner surface of the slip ring and shaft when the slip ring is positioned away from the transition portion of the shaft, the inner surface being also complementary with the transition portion of the shaft so that when the slip ring abuts the transition portion of the shaft, the bore will be substantially sealed by the slip ring.

2. The conveying device of claim 1 wherein the retaining structure comprises a plurality of vanes spaced equidistantly around the distal end of the forward portion of the shaft.

3. The conveying device of claim 1 wherein the outlet of the housing is substantially longitudinally aligned with the bore formed through the housing.

4. The conveying device of claim 1 wherein the shaft is reciprocable within the housing between a rearmost position and a forward-most position, the slip ring also being reciprocable between a forward-most position in which the slip ring bears against the retaining structure and a rearmost position in which the inner surface of the slip ring bears against the tapered portion of the shaft so as to seal the bore, the slip ring being moved to its forward-most position by the travel of the shaft from its forward-most position to its rearmost position, the slip ring being moved to its rearmost position by the travel of the shaft from its rearmost position to its forward-most position.

5. A conveying device for conveying viscous materials comprising:
a housing having a bore with a rear portion and a forward portion, an inlet formed through the housing so as to be in fluidic communication with the forward portion of the bore, and an outlet that is in fluidic communication with the forward portion of the bore in a position that is spaced apart from that of the inlet;
a shaft constructed and arranged for reciprocal movement within the bore of the housing, the shaft having a rear portion sized so as to form a tight, sliding fit with the rear portion of the bore and a forward portion that has a diameter that is at least marginally smaller than that of the rear portion of the bore, the forward and rear portions of the shaft being joined by a transition surface; and,
a slip ring slidably disposed within the bore of the housing and slidably captured over the forward portion of the shaft between the transition surface and a retaining structure affixed to a distal end of the forward portion of the shaft, the slip ring having an outer surface that forms a tight sliding fit with the forward portion of the bore, and an inner surface that is spaced away from the exterior of the forward portion of the shaft so as to form an annular space therebetween, the inner surface of the slip ring also having a shape that is complementary to the shape of the transition surface of the shaft such that when the inner surface of the slip ring is abutted against the transition surface of the shaft, viscous material may not flow past the slip ring.

6. The conveying device of claim 5 wherein the forward movement of the shaft from a first, retracted position, to a second, extended position, causes the inner surface of the slip ring to abut the transition surface of the shaft, the tight sliding fit between the exterior surface of the slip ring and the bore and the close, complementary fit between the transition surface of the shaft and the inner surface of the slip ring effectively forming a piston head that pushes viscous material ahead of it as the shaft moves between its first and second positions.

7. The conveying device of claim 6 wherein the travel of the shaft from its second, extended position towards its first, retracted position, causes the slip ring to be moved away from the transition surface of the shaft, thereby creating an annular flow channel between the inner surface of the slip ring and the exterior surface of the forward portion of the shaft, permitting the flow of viscous materials into the forward portion of the housing bore.

8. The conveying device of claim 5 wherein viscous material is continuously pumped into the forward portion of the bore of the housing through the inlet formed through the housing.

9. The conveying device of claim 8 wherein viscous materials accumulated within the forward portion of the bore in the housing are intermittently ejected from the bore through the outlet into a downstream device.

10. The conveying device of claim 9 wherein the viscous material comprises a molding compound and the downstream device comprises a molding device.

11. The conveying device of claim 5 where in the transition surface is one of a frustoconical surface, a flat, perpendicular shoulder, a section of a toroidal surface, and a curved surface.

12. A conveying device for conveying viscous materials comprising:
a housing having a bore formed therein, the housing also having formed therethrough an inlet and an outlet, each in fluidic communication with the bore formed in the housing;
a reciprocable collar slidably received within an open end of the bore, an exterior surface of the collar forming a tight sliding fit with the interior of the open end of the bore;
a shaft reciprocally received within the collar received in the open end of the bore, the exterior of the shaft forming a tight sliding fit with the interior surface of the collar, the shaft being sized such that an annular space exists between the shaft and the bore of the housing, the inlet and outlet of the bore being in fluidic communication with this annular space, the shaft further having a forward portion and a rear portion that are joined by a transition surface; and,
a slip ring slidably received within the bore and slidably captured over the forward portion of the shaft and wherein an outer surface of the slip ring forms a tight sliding fit with the bore of the housing, and wherein the slip. ring may be moved longitudinally with respect to the shaft between the transition surface of the shaft and a retaining structure coupled to a distal end of the forward portion of the shaft, the slip ring and the forward portion of the shaft being constructed and arranged such that when the slip ring is positioned away from the transition surface there exists a flow passage between the inner surface of the slip ring and the shaft, the inner surface of the slip ring being further constructed and arranged to be complementary with the transition surface of the shaft.

13. The conveying device of claim 12 wherein the position of the collar within the bore is controlled so as to change the volume of the annular space formed between the shaft and the bore of the housing.

14. The conveying device of claim 12 wherein the forward movement of the shaft from a first, retracted position, to a second, extended position, causes the inner surface of the slip ring to become positioned in contact with the transition surface of the shaft, the tight sliding fit between the exterior surface of the slip ring and the bore and the close, complementary fit between the transition surface of the shaft and the inner surface of the slip ring effectively forming a piston head that pushes viscous material ahead of it as the shaft moves between its first and second positions.

15. The conveying device of claim 12 wherein the transition surface is defined by a retaining structure that prevents the longitudinal travel of the slip ring therepast, the transition surface of the shaft and the inner surface of the slip ring being sufficiently close fitting so as to prevent the flow of the viscous materials therebetween when the inner surface of the slip ring is in contact with the transition surface of the shaft.

16. The conveying device of claim 12 wherein the transition surface is defined by one of a frustoconical surface, a perpendicular shoulder, and a radiused shoulder.

17. The conveying device of claim 14 wherein the travel of the shaft from its second, extended position towards its first, retracted position, causes the slip ring to be moved away from the transition surface of the shaft, thereby creating an annular flow channel between the inner surface of the slip ring and the exterior surface of the forward portion of the shaft, permitting the flow of viscous materials into the forward portion of the housing bore.

18. The conveying device of claim 12 wherein viscous material is continuously pumped into the forward portion of the bore of the housing through the inlet formed through the housing.

19. The conveying device of claim 18 wherein viscous materials accumulated within the forward portion of the bore in the housing are intermittently ejected from the bore through the outlet into a downstream device.

20. The conveying device of claim 19 wherein the viscous material comprises a molding compound and the downstream device comprises a molding device.

21. A method of continuously accumulating and intermittently conveying a molding material from a conveying device comprising a housing having a bore with a rear portion and a forward portion, an inlet formed through the housing so as to be in fluidic communication with the forward portion of the bore, and an outlet that is in fluidic communication with the forward portion of the bore in a position that is spaced apart from that of the inlet, a shaft constructed and arranged for reciprocal movement within the bore of the housing, the shaft having a rear portion sized so as to form a tight, sliding fit with the rear portion of the bore and a forward portion that has a diameter that is at least marginally smaller than that of the rear portion of the bore, the forward and rear portions of the shaft being joined by a transition surface and a slip ring slidably disposed within the bore of the housing and slidably captured over the forward portion of the shaft between the transition surface and a retaining structure affixed to a distal end of the forward portion of the shaft, the slip ring having an outer surface that forms a tight sliding fit with the forward portion of the bore, an inner surface of the slip ring having a shape that is complementary to the shape of the transition surface of the shaft such that when the inner surface of the slip ring is abutted against the transition surface of the shaft, viscous material may not flow past the slip ring, the inner surface of the slip ring and the shaft being formed such that there exists a flow channel therebetween when the slip ring is positioned away from the transition surface of the, the method comprising the steps of:
injecting continuously a molding material into an annular passage formed between the forward portion of the interior of the bore formed through the housing and the forward portion of the shaft so that the molding material will continuously be accumulated in the annular passage;
retracting the shaft to a first, retracted position wherein the slip ring slidably captured on the forward portion of the shaft abuts the retaining structure affixed to the distal end of the shaft and the molding material may flow between the inner surface of the slip ring and the forward portion of the shaft; and,
extending the shaft to a second, extended position wherein the slip ring slidably captured on the forward portion of the shaft is positioned against the retaining structure immediately adjacent the transition surface, the slip ring acting to push the molding material accumulated forward of the slip ring from the housing of the conveying device through the outlet of the bore.
